(19) United States
(12) Patent Application Publication
(10) Pub. No.: US 2017/0157514 A1
(43) Pub. Date: Jun. 8, 2017

(54) Condition Ascertainment Unit

(71) Applicant: Daiwa House Industry Co., Ltd., Osaka (JP)

(72) Inventors: Tsukasa Nakano, Osaka (JP); Takashi Orime, Osaka (JP); Kenji Hirosawa, Osaka (JP); Hiroyuki Yajima, Osaka (JP); Kenichi Honda, Osaka (JP); Yasuo Takahashi, Osaka (JP)

(21) Appl. No.: 15/300,082

(22) PCT Filed: Mar. 26, 2015
(86) PCT No.: PCT/JP2015/059391

§ 371 Date: Sep. 28, 2016

(30) Foreign Application Priority Data
Mar. 28, 2014 (JP) 2014-068735

(51) Int. Cl. A63F 13/30; A63F 13/212; A63F 13/28; H04N 21/234; H04N 7/14; H04N 7/15; H04N 21/218; A63F 13/211; A63F 13/31

(52) U.S. Cl. CPC A63F 13/55

(57) ABSTRACT

A condition ascertainment unit accurately ascertains the condition of an opponent in a remote location while considering an opponent's privacy. The condition ascertainment unit for ascertaining the condition of the opponent in a remote location includes a staging device configured to perform a staging operation different from the operation of reproducing a video image and voice of the opponent, and a control device configured to control the staging device to perform the staging operation and to communicate with an opponent side terminal. The control device obtains data on at least one of opponent's position and state, atmosphere in the space where the opponent is present, voice emitted from the opponent, and vibration generated by action of the opponent; specifies, from the obtained data, contents on the above-described item; and causes the staging device to perform the staging operation in a staging mode corresponding to the specified contents.

### CROSS REFERENCE TO RELATED APPLICATION

The present application claims priority to Japanese Patent Application No. 2014-068735 filed on Mar. 28, 2014, the entire content of which is herein incorporated by reference.

### TECHNICAL FIELD

The present invention relates to a condition ascertainment unit used by a user for ascertaining the condition of an opponent in a remote location, and particularly relates to a condition ascertainment unit being able to ascertain the condition of the opponent in the method different from the method for reproducing a video image and voice of the opponent.

### BACKGROUND

For a person in a remote location, a communication technique used for a video conference etc. is effective to monitor the presence or absence of the person at home and the health condition of the person. That is, according to this communication technique, a dialogue can be held while parties interested are looking at each other. Each party (each communicator) in communication can check opponent's expression and state, and therefore, can determine whether or not there is an abnormality in the opponent.

On the other hand, for the person to be monitored (i.e., the communication partner), there might be the case where the person does not wish to show oneself because of an issue such as a privacy. For this reason, the technique of protecting the privacy of the person to be monitored has been demanded for the communication technique of holding a dialogue between persons in remote locations. Some techniques have been described as examples of the above-described technique in JP 2012-100185, JP 2012-227624, JP 2001-16564 and JP 2001-309325.

JP 2012-100185 describes that when a sleeping person is detected by a video conference system, transmission of a video image and voice is temporarily suspended, and such suspended transmission is resumed when it is determined that the sleeping person wakes up. According to such a technique, since the video image is not available while the person is sleeping, the privacy of the sleeping person can be protected.

Similarly, JP 2012-227624, JP 2001-16564 and JP 2001-309325 also disclose the technique of protecting the privacy of a communicator (or a communication partner) at a video conference or in communication via a videophone. Specifically, JP 2012-227624 discloses a still image is displayed on a selected region of a display screen for displaying an image. JP 2001-16564 and JP 2001-309325 disclose that a video image of a person oneself and a pre-recorded image are combined with each other, and then, the combined image with clothes, a hair style, a background, etc. different from actual clothes, an actual hair style, an actual background, etc. is transmitted to a communication partner.

However, when privacy protection is excessively emphasized, it might be difficult to accurately ascertain the condition of a communication partner. For example, when transmission of the video image and the voice is suspended as described in JP 2012-100185, the video image and the voice cannot be obtained during suspension. For this reason, even if an abnormality occurs during the suspension period, it is difficult to find such an abnormality. Moreover, when the still image is displayed on the particular region of the display screen as described in JP 2012-227624, it is difficult to properly ascertain the state of a communication partner oneself and the surrounding atmosphere of the communication partner. Similarly, when the combined image of the actual video image and other video image (the pre-recorded video image) is transmitted as described in JP 2001-16564 and JP 2001-309325, a communication partner's image and a surrounding environment image are intentionally changed. For this reason, it is difficult to properly ascertain the state of a communication partner and the surrounding atmosphere of the communication partner.

It is important in a smooth conversation with a communication partner to ascertain the state of the communication partner and the surrounding atmosphere of the communication partner. In this sense, the techniques disclosed in JP 2012-100185, JP 2012-227624, JP 2001-16564 and JP 2001-309325 might not sufficiently realize a smooth conversation between persons in remote locations. The present invention has been made in view of the above-described problems, and is intended to provide a condition ascertainment unit being able to accurately ascertain the condition of an opponent in a remote location while considering the privacy of the opponent.

### SUMMARY

The above-described problems are solved by a condition ascertainment unit of the present invention. Such a condition ascertainment unit is a condition ascertainment unit used by a user for ascertaining the condition of an opponent in a remote location, the condition ascertainment unit including (A) a staging device configured to perform a staging operation being recognizable by the user and being different from the operation of reproducing a video image and voice of the opponent, and (B) a control device configured to control the staging device to perform the staging operation and to communicate with an opponent side terminal used by the opponent. (C) The control device executes (c1) the data obtaining processing of obtaining, via communication with the opponent side terminal, data indicating at least one of the presence or absence of the opponent, a video image including an image of the opponent, sound collected in the space where the opponent is present, or vibration generated by action of the opponent, (c2) the content specifying processing of specifying, from the data obtained by the data obtaining processing, contents on at least one of the position of the opponent, the state of the opponent, or atmosphere in the space where the opponent is present, and (c3) the staging request processing of causing the staging device to perform the staging operation in a staging mode corresponding to the contents specified by the content specifying processing.

In the condition ascertainment unit of the present invention configured as described above, the staging device performs the staging operation different from the operation of reproducing the video image and the voice of the opponent. Moreover, the staging device specifies the contents on at least one of the position and state of the opponent, the atmosphere in the space where the opponent is present, the voice emitted from the opponent, and the vibration generated by the action of the opponent, and then, performs the staging operation in the staging mode corresponding to such specified results. Thus, the condition of the opponent can be ascertained through the staging operation without reproducing the video image and the voice of the opponent. As a result, the condition of the opponent can be accurately ascertained while the privacy of the opponent is protected. This realizes a favorable smooth conversation with the opponent.

Preferably, in the above-described condition ascertainment unit, the control device obtains, in the data obtaining processing, sound data indicating the sound collected in the space where the opponent is present, and then, specifies, in the content specifying processing, at least one of the volume or the quality of the sound indicated by the sound data.

According to the above-described configuration, the volume and the quality of the sound collected in the space where the opponent is present are specified, and the staging device performs the staging operation in the staging mode corresponding to such specified results. The volume and the quality of the sound collected in the space where the opponent is present are effective information in ascertaining of the state of the opponent and the surrounding atmosphere of the opponent. Since the staging operation is performed in the staging mode corresponding to the volume and the quality of the sound collected in the space where the opponent is present, the user can more accurately ascertain the condition of the opponent.

More preferably, in the above-described condition ascertainment unit, the control device obtains, in the data obtaining processing, position data indicating the position of the opponent and the sound data; and specifies, in the content specifying processing, at least one of the volume or the quality of the sound indicated by the sound data, and specifies the position of the opponent with respect to a reference position in the space where the opponent is present.

According to the above-described configuration, the volume and the quality of the sound collected in the space where the opponent is present are specified, and the position of the user in such a space is also specified. The staging mode is performed in the staging mode corresponding to such specified results. As a result, the user can ascertain the current position of the opponent and the current condition of the opponent.

Much more preferably, in the above-described condition ascertainment unit, the staging device executes the staging operation of displaying a pattern image on a display screen; and the control device, in execution of the staging request processing, sets a display mode of the pattern image as the staging mode, and causes the staging device to perform the staging operation such that the pattern image is displayed in the display mode corresponding to the contents specified by the content specifying processing.

According to the above-described configuration, the operation of displaying the pattern image is performed as the staging operation, and the display mode of the pattern image in such a display operation is the mode corresponding to the state of the opponent and the surrounding atmosphere of the opponent. As a result, the user can accurately ascertain the condition of the opponent through visual staging using the pattern image.

Much more preferably, in the above-described condition ascertainment unit, when the contents specified by the content specifying processing change, the control device, in the staging request processing, switches the display mode along with the content change, and causes the staging device to perform the staging operation such that the pattern image is displayed in the display mode after being switched.

According to the above-described configuration, when the state of the opponent and the surrounding atmosphere of the opponent change, the display mode of the pattern image is switched along with such change. Thus, when the condition of the opponent changes, the user can notice such change.

More preferably, the above-described condition ascertainment unit further includes a reproduction device configured to perform the reproduction operation of reproducing at least one of the video image or the voice of the opponent, and operation receiving equipment configured to receive an operation performed by the user to cause the reproduction device to perform the reproduction operation. When the operation receiving equipment receives the operation, the control device further executes the reproduction request processing of controlling the reproduction device to perform the reproduction operation, and the operation receiving equipment receives the operation while the staging device is performing the staging operation.

According to the above-described configuration, the staging operation is performed before the reproduction operation, and the reproduction operation begins under the condition that the user operation for beginning the reproduction operation is performed during the staging operation. Since the reproduction operation begins after the staging operation, the situation where the reproduction operation unexpectedly begins without performing the staging operation is avoided, and therefore, the privacy of the opponent can be more effectively protected.

Much more preferably, in the above-described condition ascertainment unit, the staging device and the reproduction device are configured as a common device.

According to the above-described configuration, since the staging device and the reproduction device are configured as the common device, an increase in the number of devices/equipment forming the condition ascertainment unit can be suppressed. As a result, the configuration of the condition ascertainment unit including the reproduction device can be simplified.

According to the condition ascertainment unit of the present invention, the condition of the opponent can be ascertained without reproducing the video image and the voice of the opponent. That is, the condition ascertainment unit of the present invention can be used to accurately ascertain the condition of the opponent while protecting the privacy of the opponent. Since the opponent side condition is ascertained, a conversation can be held with the opponent based on such a condition. Thus, a smooth conversation (communication) can be realized. As described above, the condition ascertainment unit of the present invention can be effectively utilized as a tool for a favorable conversation between persons in remote locations.

### BRIEF DESCRIPTION OF THE DRAWINGS

FIG. 1 is a view for describing a use example of a condition ascertainment unit of the present invention;

FIG. 2 is a block diagram of a configuration of a condition ascertainment unit of an embodiment of the present invention;

FIG. 3 is a list of functions of a control device of the embodiment of the present invention;

FIG. 4 is a flowchart of a dialogue communication flow;

FIG. 5 is a flowchart of steps of condition specifying processing;

FIG. 6 is a view for describing the method for specifying the position of an opponent;

FIG. 7 is a diagram for describing the method for specifying, e.g., atmosphere in the space where the opponent is present;

FIG. 8 is a view for describing the method for specifying the expression of the opponent;

FIG. 9 is a view for describing the method for specifying the walking vibration of the opponent;

FIG. 10A is a flowchart of steps of staging request processing (No. 1);

FIG. 10B is a flowchart of the steps of staging request processing (No. 2);

FIG. 11 is a view for describing a display mode of a pattern image; and

FIG. 12 is a table of the correspondence between a facial expression and BGM targeted for playback.

### DETAILED DESCRIPTION OF THE EMBODIMENTS

An embodiment (hereinafter referred to as a “present embodiment”) of the present invention will be described below with reference to drawings.

### Summary of Condition Ascertainment Unit of Present Embodiment

First, a condition ascertainment unit of the present embodiment will be briefly described.

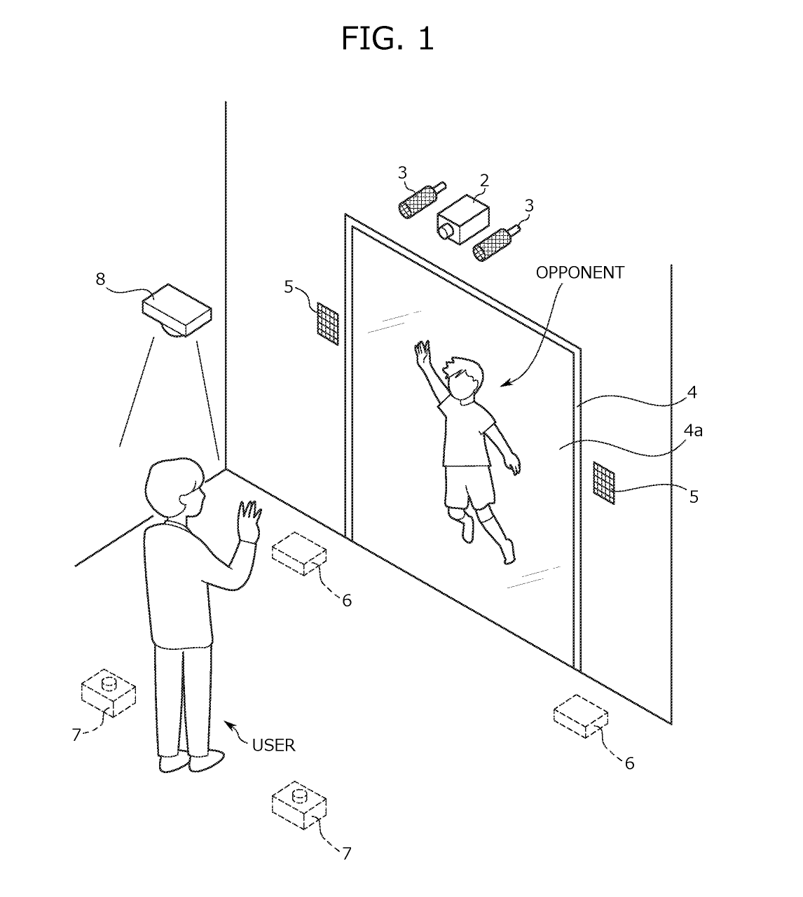

The condition ascertainment unit of the present embodiment is used by a user for ascertaining the condition of an opponent in a remote location. Moreover, a majority of a configuration of the condition ascertainment unit of the present embodiment is common to that of a dialogue communication unit utilized for, e.g., a video conference system. For this reason, the condition ascertainment unit of the present embodiment is used by the user for the purpose of having a face-to-face dialogue with the opponent in the remote location as illustrated in FIG. 1.

Specifically, the user and the opponent (one may be hereinafter sometimes referred to as a “communicator,” and the other may be hereinafter sometimes referred to as a “communication partner”) each own the condition ascertainment unit of the present embodiment. More specifically, the condition ascertainment unit of the present embodiment is provided at each home of the communicator and the communication partner. The communicator uses the condition ascertainment unit of the present embodiment to have a dialogue with the communication partner in a room (hereinafter referred to as a “communication room”), where a device forming the condition ascertainment unit is placed, at home.

Note that the dialogue using the condition ascertainment unit is not limited to the case of communication at the communicator's home, and may be held at other building (e.g., a facility or a building utilized by the communicator) than home.

### Basic Configuration of Condition Ascertainment Unit

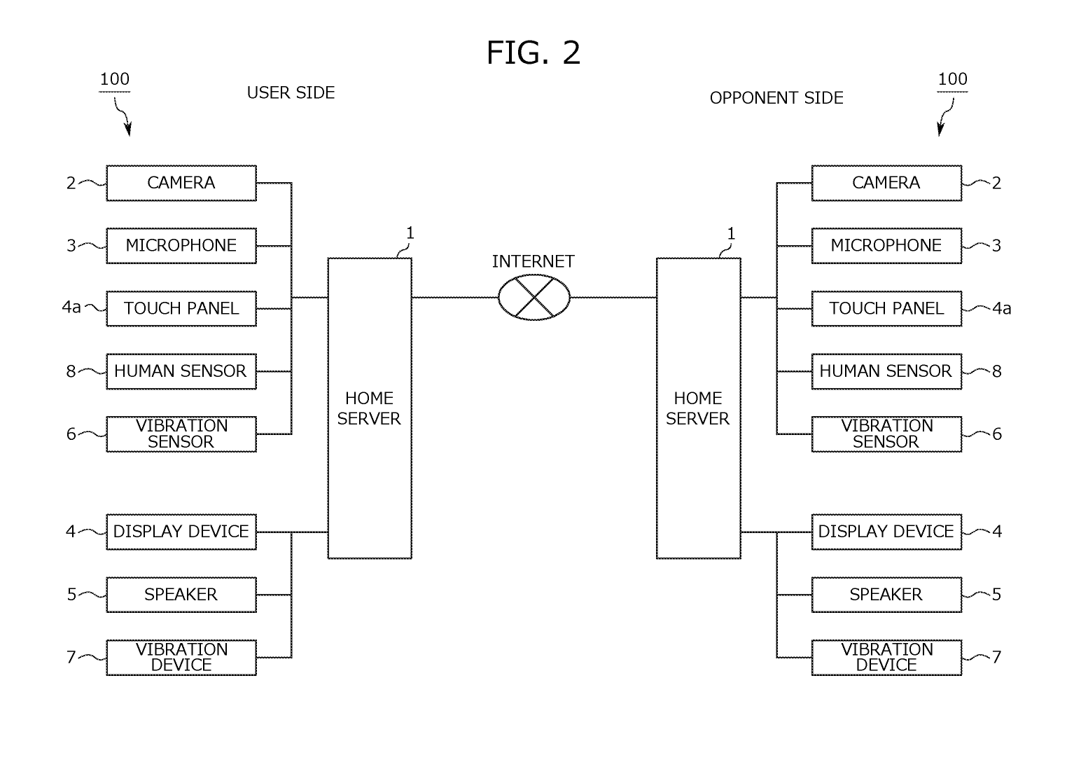

A basic configuration of the condition ascertainment unit of the present embodiment will be described with reference to FIGS. 1 and 2. A condition ascertainment unit (hereinafter referred to as a “present unit”) 100 of the present embodiment is owned by each of the user and the opponent as described above, and an equipment configuration is common between these units. Thus, the configuration of the present unit 100 (specifically, the user-side present unit 100) owned by one of the communicators will be described below as an example.

As illustrated in FIG. 1, the present unit 100 includes a camera 2 and microphones 3 as input devices configured to obtain a video image/voice of the user, as well as including display device 4 and speakers 5 as output devices configured to reproduce a video image/voice of the opponent. These devices are placed in the communication room of the home of the user.

The camera 2 is formed of a well-known imaging recorder, and an imaging area thereof is set at the inside of the communication room. When the user is in the imaging area, the camera 2 images the entire body of the user and the surrounding space of the user. Each microphone 3 is formed of a well-known sound collecting microphone, and is configured to collect voice (sound) emitted from the user and the periphery thereof in the communication room while the user is in such a communication room. Note that in the present embodiment, two microphones 3 in total are placed, one being positioned on each side of the camera 2 as illustrated in FIG. 1. With the microphones 3 placed respectively at two points on the right and left sides, the position of the user emitting voice, i.e., a sound image position, can be specified from the sound (specifically, the phase difference between sound waveforms) collected by the microphones 3. Note that the number of microphones 3 to be placed and the position where each microphone 3 is placed are not limited, and may be optionally set.

The display device 4 corresponds to a reproduction device configured to reproduce (display) the video image of the opponent. The display device 4 of the present embodiment has a rectangular outer shape as illustrated in FIG. 1, and a display screen for displaying a video image is formed on the front surface of the display device 4. The display screen has such a size that the video image of the entire body of the opponent and the video image of the surrounding environment of the opponent can be displayed. The display device 4 of the present embodiment is disposed on a wall in the communication room as illustrated in FIG. 1. Note that the arrangement position of the display device 4 is not limited, and may be set at an optional position.

The display device 4 is equipped with a touch panel 4a. The touch panel 4a forms the above-described display screen, and serves as operation receiving equipment configured to receive a user's operation (specifically, a touch operation). Note that the operation receiving equipment is not limited to the touch panel 4a, and typical input equipment including, e.g., a keyboard and a mouse may be used as the operation receiving equipment.

Each speaker 5 corresponds to a reproduction device configured to reproduce (play back) the voice of the opponent and the surrounding sound of the opponent. Each speaker 5 used in the present embodiment has the configuration similar to that of a typical speaker. As illustrated in FIG. 1, two speakers 5 in total are placed, one being positioned on each side of the display device 4 as illustrated in FIG. 1. With the speakers 5 placed respectively at two points on the right and left sides, the position of the sound image can be adjusted on a user side. That is, the phase, amplitude, etc. of the sound emitted from each speaker 5 are controlled separately for the speakers 5, and therefore, the position of the sound image sensed by the user can be adjusted. The sound image position is adjustable, and as a result, an audiovisual effect can be obtained, which allows the user to hear the voice from the direction of the opponent displayed on the display device 4. Note that the number of speakers 5 to be placed and the position where each speaker 5 is placed are not limited, and may be optionally set.

In addition to the above-described equipment, vibration sensors 6 as input devices and vibration devices 7 as output devices are, in the present embodiment, further provided as components of the present unit 100.

Each vibration sensor 6 is formed of a well-known acceleration sensor. Each vibration sensor 6 is placed on the floor of the communication room, and is configured to detect vibration (hereinafter referred to as “walking vibration”) generated when the user walks on the floor. In the present embodiment, the plurality of vibration sensors 6 are arranged in the front of the display device 4 as illustrated in FIG. 1. Strictly speaking, the vibration sensors 6 are placed respectively at two points on the right and left sides with a clearance being formed between the sensors. With the vibration sensors 6 placed respectively at two points on the right and left sides, the position of the user as the generation source of the walking vibration can specified from the detection result of the walking vibration (specifically, the phase difference between walking vibration waveforms) detected by the vibration sensors 6. Note that the number of vibration sensors 6 to be placed and the position where each vibration sensor 6 is placed are not limited, and may be optionally set.

Each vibration device 7 is a device configured to reproduce the walking vibration of the opponent, and is provided to contact the back surface of a flooring material forming the floor of the communication room. Moreover, each vibration device 7 is formed of an actuator configured to provide vibration to the floor by a mechanical operation. Each vibration device 7 provides vibration to the floor in synchronization with the video image displayed on the display device 4. With this configuration, the floor vibrates in conjunction with the opponent's video image (specifically, the video image of the walking opponent) displayed on the display device 4. Since vibration accompanied with walking of the opponent can be reproduced on the user side, the user senses (i.e., realistic sensation) as if the user is having a dialogue with the opponent in the same space.

In the present embodiment, the plurality of vibration devices 7 are arranged respectively at the positions somewhat separated forward from the display device 4. Strictly speaking, the vibration devices 7 are placed respectively at two points on the right and left sides with a clearance being formed between the devices. With the vibration devices 7 placed respectively at two points on the right and left sides, the generation position of the opponent's walking vibration reproduced on the user side can be adjusted. That is, the phase, amplitude, etc. of the vibration generated from each vibration device 7 are controlled separately for the vibration devices 7, and therefore, the generation position of the walking vibration sensed by the user can be adjusted. The walking vibration generation position is adjustable, and as a result, an effect can be obtained, which allows the walking vibration to be transmitted from the standing position of the opponent displayed on the display device 4. Thus, realistic sensation in a dialogue is further improved. Note that the number of vibration devices 7 to be placed and the position where each vibration device 7 is placed are not limited, and may be optionally set. Moreover, each vibration device 7 is not limited to the actuator, and other equipment such as a vibration speaker may be employed as long as the equipment can suitably vibrate the floor.

In addition to each device described so far, the present unit 100 further includes a home server 1 as illustrated in FIG. 2. The home server 1 is a so-called “home gateway,” and includes a CPU, a memory with a RAM or a ROM, a hard disk drive, and a communication interface. The memory of the home server 1 stores various types of programs and data.

The programs stored in the memory are read and executed by the CPU, and then, the home server 1 executes a series of processing for a user's dialogue with the opponent to control a corresponding one of the above-described devices in each processing step. That is, the home server 1 functions as a control device, and is communicatively connected to each device.

Moreover, the home server 1 is configured to communicate with an opponent side terminal used for opponent's dialogue communication, specifically an opponent side home server (hereinafter referred to as an “opponent side server”), to transmit/receive data to/from the opponent side server. That is, the home server 1 is communicatively connected to the opponent side server via an external communication network such as the Internet. The home server 1 obtains, via communication with the opponent side server, video image data indicating the video image of the opponent and sound data indicating the sound collected in the communication room of the home of the opponent. Moreover, the home server 1 transmits, to the opponent side server, video image data indicating the video image of the user and sound data indicating the sound collected in the communication room of the home of the user.

Note that in the present embodiment, the video image data transmitted from the user's home server 1 or the opponent side server is to be transmitted in the format of data on which the sound data is superimposed, specifically in the format of video file data. In reproduction of the video image and the sound stored as the video file data, the video image data and the sound data are extracted from the video file data, and each type of extracted data is expanded.

Data on the walking vibration generated by walking of the opponent is contained in the data received from the opponent side server by the home server 1. Such data is data indicating the amplitude, phase, etc. of the walking vibration, and is hereinafter referred to as “vibration data.” The vibration data on the walking vibration generated by walking of the user is similarly contained in the data transmitted from the home server 1 to the opponent side server.

The home server 1 of the present embodiment begins a series of processing for dialogue communication, using entry of the user into the communication room as a trigger (a start requirement). More specifically, the present unit 100 further includes a human sensor 8 as a component, as illustrated in FIG. 2. The human sensor 8 is configured to detect the presence of a person in a detection area thereof, and is attached to a predetermined section of the communication room of the user's home, such as the ceiling. That is, the inner space of the communication room is set as the detection area of the human sensor 8. When the user is in the inner space as the detection area, the human sensor 8 detects the user to output, to the home server 1, an electrical signal indicating the detection result. While the user is in the communication room, the human sensor 8 continuously outputs the above-described electrical signal.

Meanwhile, when the home server 1 receives the electrical signal output from the human sensor 8, the home server 1 actuates the camera 2, the microphones 3, and the vibration sensors 6 to receive a signal input from each device. That is, the home server 1 causes, using reception of the output signal of the human sensor 8 as a trigger, the camera 2 to image the user and the surrounding space thereof, causes the microphones 3 to collect the sound generated in the communication room, and causes the vibration sensors 6 to detect the vibration (the walking vibration) generated by walking of the user.

Moreover, when receiving the signal output from the human sensor 8, the home server 1 begins communicating with the opponent side server. At this point, if the opponent is in the communication room of the home of the opponent, the video file data and the vibration data are to be transmitted from the opponent side server. On the other hand, the home server 1 is to receive the video file data and the vibration data transmitted from the opponent side server.

### Functions of Home Server

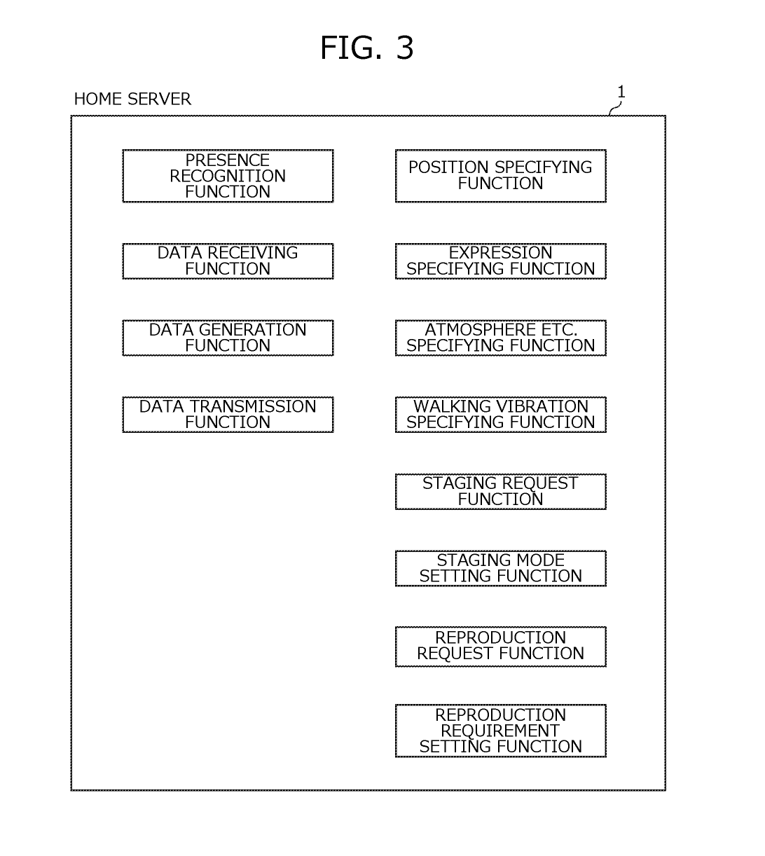

Next, the functions of the home server 1 of the present embodiment will be described with reference to FIG. 3. The home server 1 executes a series of processing for the user's dialogue with the opponent. In other words, the home server 1 has the functions of sequentially executing each required processing step in dialogue communication. Specifically, as illustrated in FIG. 3, the home server 1 has a “presence recognition function,” a “data receiving function,” a “data generation function,” a “data transmission function,” a “reproduction request function,” and a “reproduction requirement setting function.”

The presence recognition function is the function of receiving, while the user is in the communication room, the electrical signal output from the human sensor 8 to recognize the presence of the user in the communication room. After the presence of the user in the communication room has been recognized by the presence recognition function, the later-described other functions are exhibited.

The data receiving function is the function of receiving the video file data and the vibration data from the opponent side server via the Internet. That is, the home server 1 executes, as the processing for the user's dialogue with the opponent, the data obtaining processing of communicating with the opponent side server to obtain the video file data and the vibration data. Note that the home server 1 of the present embodiment requests, as the preliminary step of executing the data obtaining processing, the opponent side server to provide presence information. The presence information is information on the presence or absence of the opponent, simply speaking information on whether or not the opponent is in the communication room of the home of the opponent. When receiving the data indicating the presence information from the opponent side server, the home server 1 confirms, from the presence information, that the opponent is in the communication room, and then, executes the data obtaining processing.

The data generation function is the function of generating the video image data from a video image signal indicating the video image obtained by the camera 2 and generating the sound data from a sound signal indicating the sound collected by the microphones 3. Further, according to the data generation function, the sound data is superimposed on the generated video image data, and as a result, the video file data is generated.

The data transmission function is the function of transmitting, to the opponent side server, the video file data generated by the data generation function and the vibration data (strictly speaking, the data generated by the home server 1 as the data corresponding to the obtained vibration data) obtained by the vibration sensors 6.

The reproduction request function is the function of controlling the display device 4 and the speakers 5 as the reproduction device to perform the reproduction operation of reproducing the video image and the voice of the opponent. That is, the home server 1 executes reproduction request processing as the processing for the user's dialogue with the opponent. In the reproduction request processing, the video image data and the sound data are first extracted from the video file data received from the opponent side server. Subsequently, after the extracted video image data and the extracted sound data have been expanded, the request for reproducing the video image and the sound indicated by each type of data is generated, and the generated request is output to the display device 4 and the speakers 5. When receiving the request from the home server 1, the display device 4 and the speakers 5 perform the reproduction operation according to such a request.

Moreover, in the present embodiment, the reproduction request function includes the function of performing the reproduction operation of controlling the vibration devices 7 to reproduce the walking vibration of the opponent. That is, the home server 1 executes the processing (the reproduction request processing) of causing the vibration devices 7 to perform the reproduction operation of reproducing the walking vibration of the opponent. In such processing, the vibration data received from the opponent side server is first expanded. Subsequently, the request for reproducing the walking vibration of the opponent is generated, and then, the generated request is output to the vibration devices 7. When receiving the request from the home server 1, the vibration devices 7 perform the reproduction operation, i.e., vibration providing operation, according to the request.

The reproduction requirement setting function is the function of setting requirements when each of the display device 4, the speakers 5, and the vibration devices 7 performs the reproduction operation. The reproduction requirements set by this function are to be incorporated into the request generated in the reproduction request processing.

Regarding setting of the reproduction requirements, the reproduction requirements are to be set based on the data received from the opponent side server (specifically, the video file data and the vibration data). More specifically, the speakers 5 are, as described above, placed respectively at two points on the right and left sides in the communication room of the home of the user, and the reproduction requirements (specifically, the volume, phase, etc. of generated sound) are to be set for each speaker 5. On the other hand, the microphones 3 are placed respectively at two points on the right and left sides in the communication room of the home of the opponent, and the sound data indicating the volume and the phase of the sound collected by the microphones 3 is transmitted from the opponent side server in the format of video file data. Then, the home server 1 identifies the sound image position based on the above-described sound data received from the opponent side server, and then, the reproduction requirements are set for each speaker 5 according to such an identification result.

Moreover, the vibration devices 7 are placed respectively at two points on the right and left sides in the communication room of the home of the user, and the reproduction requirements (specifically, the amplitude, phase, etc. of generated vibration) are to be set for each vibration device 7. On the other hand, the vibration sensors 6 are provided respectively at two points on the right and left sides in the communication room of the home of the opponent, and the vibration data indicating the amplitude and the phase of the walking vibration detected by each vibration sensor 6 is transmitted from the opponent side server. Then, after having identified the generation position of the walking vibration based on the above-described vibration data received from the opponent side server, the home server 1 sets the reproduction requirements for each vibration device 7 according to such an identification result.

Using the above-described functions, the home server 1 performs dialogue communication with the opponent side server. As a result, the user can have a conversation (a dialogue) with the opponent via the microphones 3 and the speakers 5 while viewing the entire body image of the opponent and the surrounding space image of the opponent on the display screen of the display device 4.

As described in the “Technical Problem” section, the privacy of the opponent needs to be taken into consideration in dialogue communication. For example, when the video image and the voice of the opponent are promptly reproduced after the signal output from the human sensor 8 has been received, even if the opponent does not wish to communicate the appearance and the voice of the opponent oneself with the user, the video image and the voice are reproduced against the opponent's wish.

On the other hand, if privacy protection is excessively emphasized, it might be difficult to accurately ascertain the condition of the opponent, specifically the state of the opponent and the surrounding atmosphere of the opponent. Moreover, it is important in a smooth dialogue (communication) with the opponent to properly ascertain the condition of the opponent.

For these reasons, in the present embodiment, the processing of ascertaining the condition of the opponent is executed as the preliminary step of reproducing the video image and the voice of the opponent in a series of processing for dialogue communication, and the home server 1 has the function (hereinafter sometimes referred to as a “condition ascertaining function”) of executing such processing. Such a condition ascertaining function is the original function of the home server 1 as the component of the condition ascertainment unit, and the present embodiment is characterized by such a function.

Specifically, in the present embodiment, a staging operation different from the operation of reproducing the video image and the voice of the opponent is performed as the preliminary step of reproducing the video image and the voice of the opponent. Such a staging operation can be recognized by the five senses of the user, and is performed for the purpose of ascertaining the condition of the opponent. Note that in the present embodiment, the operation of displaying an image as an alternative to the video image of the opponent, the operation of reproducing sound or music as an alternative to the voice of the opponent, and the operation of providing vibration are performed as the staging operation, for example. Note that the contents of the staging operation are not limited to the above-described contents. As long as the condition of the opponent can be ascertained by user's recognition of the staging operation, the operation of emitting odor or the operation of switching a lighting device or an air-conditioner operation state may be performed as the staging operation, for example.

The staging operation is performed by the display device 4, the speakers 5, and the vibration devices 7 as described above. That is, in the present embodiment, the display device 4, the speakers 5, and the vibration devices 7 as the reproduction device also function as a staging device configured to perform the staging operation. In other words, in the present embodiment, the staging device and the reproduction device are configured as a common device. Thus, the configuration of the present unit 100 is more simplified as compared to the configuration in which a staging device and a reproduction device are separately prepared.

The staging operation will be briefly described. The contents on the condition of the opponent are specified, and a staging mode corresponding to the specified results is performed. The “condition of the opponent” is a concept including the position of the opponent, the state of the opponent, and atmosphere in the space where the opponent is present.

The “position of the opponent” is a reference position in the communication room of the home of the opponent, and is, e.g., the position of the opponent relative to the arrangement position of the display device 4. Simply speaking, the “position of the opponent” is the distance between the opponent in the communication room and the display device 4 and the direction of the opponent as viewed from the display device 4.

The “state of the opponent” is an opponent's expression, an opponent's feeling, an opponent's posture, the presence or absence of opponent's action and the contents of such action, an opponent's activity, an opponent's level of awakening, an opponent's health condition indicated by a body temperature etc., the presence or absence of an opponent's abnormality and the contents of such an abnormality, and other items on the current status of the opponent. Of the above-described items on the “state,” the expression and the feeling of the opponent are specified in the present embodiment. Note that the present invention is not limited to these items, and other items than the expression and the feeling may be specified.

The “atmosphere in the space where the opponent is present” is the level of crowding (simply speaking, the volume of sound in the room) in the space where the opponent is present, i.e., the communication room, the number of persons in the communication room, the internal environment of the communication room indicated by temperature and humidity, a lighting degree, etc., and other items on the current status of the communication room. Of the above-described items on the “atmosphere,” the level of crowding in the communication room is specified in the present embodiment. Note that the present invention is not limited to this item, and other items than the level of crowding may be specified.

As described above, the home server 1 of the present embodiment specifies the condition of the opponent when the staging operation is performed. At this point, the home server 1 specifies the condition of the opponent from the video file data and the vibration data obtained from the opponent side server. In other words, the home server 1 receives, as data required for specifying the condition of the opponent, the video file data and the vibration data from the opponent side server. In this sense, it can be said that the processing of receiving the video file data and the vibration data from the opponent side server corresponds to the data obtaining processing of obtaining the data on the condition of the opponent.

Then, the home server 1 executes the processing (the content specifying processing) of specifying the contents on the condition of the opponent from the data obtained from the opponent side server. That is, the home server 1 of the present embodiment has the function of specifying the contents on the condition of the opponent from the data obtained from the opponent side server. Such a function will be described with reference to FIG. 3. The home server 1 of the present embodiment has the “position specifying function” of specifying the position of the opponent, the “expression specifying function” of specifying the expression of the opponent, the “atmosphere etc. specifying function” of specifying the feeling of the opponent and the level of crowding in the communication room, and the “walking vibration specifying function” of specifying the contents on the walking vibration of the opponent. Note that the method for specifying each of the above-described items will be described in detail later.

After the condition of the opponent has been specified, the home server 1 executes the staging request processing of causing the display device 4, the speakers 5, and the vibration devices 7 to perform the staging operation in the staging mode corresponding to the specified results. That is, the home server 1 of the present embodiment has the staging request function of controlling the display device 4, the speakers 5, and the vibration devices 7 as the staging device to perform the staging operation.

Note that in the present embodiment, there are plural types of executable staging operations, and the user is to select, in advance, the staging operation to be actually performed from the plural types of staging operations. In the staging request processing, the home server 1 specifies the staging operation (hereinafter referred to as a “selected staging operation”) selected by the user, and generates the request for performing the selected staging operation to output the request to a device configured to perform the selected staging operation. When receiving the request, the device as the destination to which the request is output from the home server 1 performs the staging operation in a predetermined staging mode.

The staging mode is set according to the opponent's condition specified by the home server 1 at the preliminary step of the staging request processing. That is, the home server 1 of the present embodiment has the staging mode setting function of setting the staging mode according to the specified condition of the opponent. Note that the setting contents of the staging mode are incorporated into the request generated in the staging request processing.

Using the condition ascertaining functions described so far, the home server 1 causes the display device 4, the speakers 5, and the vibration devices 7 to perform the corresponding staging operation (strictly speaking, the selected staging operation) before the video image and the voice of the opponent are reproduced. The user is able to ascertain the condition of the opponent through such a staging operation, and in addition, can have a conversation (a dialogue) with the opponent via the microphones 3 and the speakers 5.

### Dialogue Communication Flow

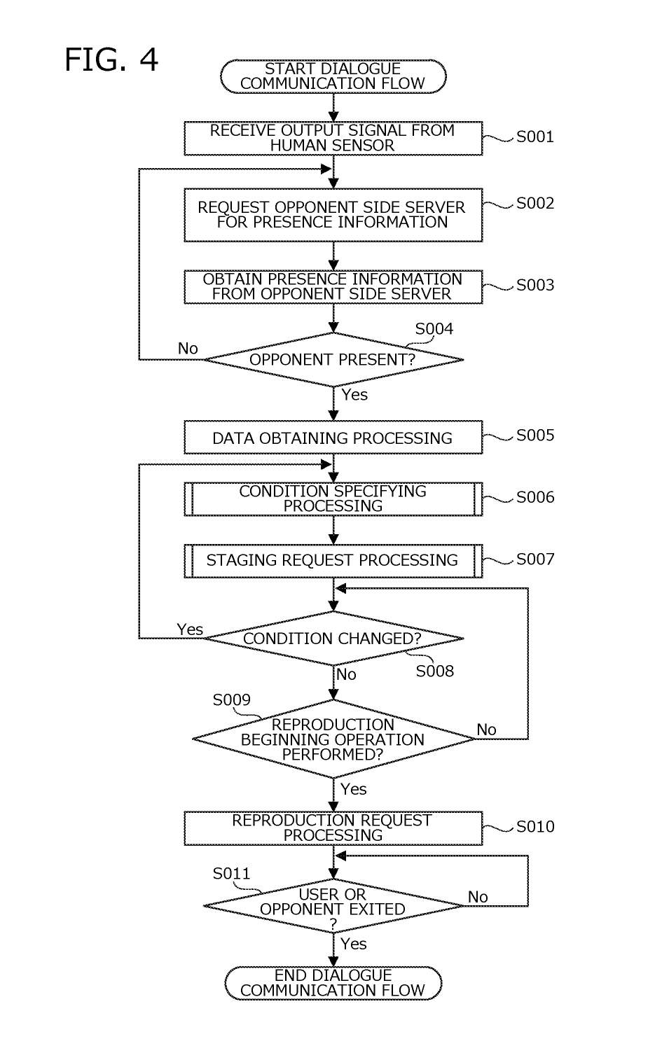

Next, a series of processing (hereinafter referred to as a “dialogue communication flow”) for dialogue communication executed by the home server 1 will be described, the series of processing including the request for performing the above-described staging operation. The dialogue communication flow proceeds as in the flow shown in FIG. 4. As shown in FIG. 4, the dialogue communication flow first begins from reception of the signal output from the human sensor 8 by the home server 1 (S001). That is, the dialogue communication flow begins when the human sensor 8 detects that the user enters the communication room and the electrical signal indicating such a detection result and output from the human sensor 8 is received by the home server 1.

Subsequently, the home server 1 requests the opponent side server to transmit the presence information (S002), and when the opponent side server having received such a request transmits the presence information, the home server 1 obtains the presence information via the Internet (S003). Then, when the home server 1 confirms, from the obtained presence information, that the opponent is in the communication room (“Yes” at S004), the home server 1 communicates with the opponent side server to receive the video file data indicating the video image, voice, etc. of the opponent (S005). Moreover, when the opponent is walking in the communication room, the home server 1 further receives the vibration data indicating the amplitude and the phase of the walking vibration generated by walking of the opponent.

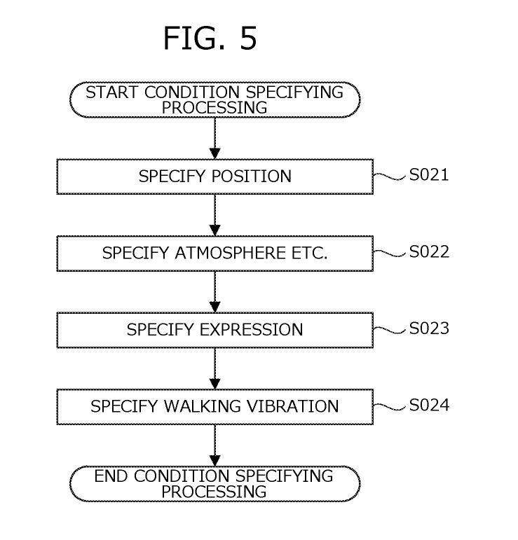

When receiving the data from the opponent side server, the home server 1 first executes the processing of specifying the condition of the opponent from the received data without promptly reproducing the video image and the voice of the opponent (S006). Such condition specifying processing proceeds as in the steps shown in FIG. 5. Specifically, in the condition specifying processing, the following steps are sequentially performed: the step of specifying the position of the opponent (S021), the step of specifying the atmosphere etc. of the opponent (S022), the step of specifying the expression of the opponent (S023), and the step of specifying the walking vibration of the opponent (S024). Note that the order in which the steps S021, S022, S023, S024 are performed is not limited, and can be freely set.

The contents of each of the steps S021, S022, S023, S024 will be described below.

At the step S201 of specifying the position of the opponent, the position of the opponent is specified from the video file data received from the opponent side server, strictly speaking the sound data extracted from the video file data. More specifically, when the extracted sound data is analyzed, the amplitude and the phase of the sound collected by the two right and left microphones 3 placed in the communication room where the opponent is present can be specified for each microphone 3.

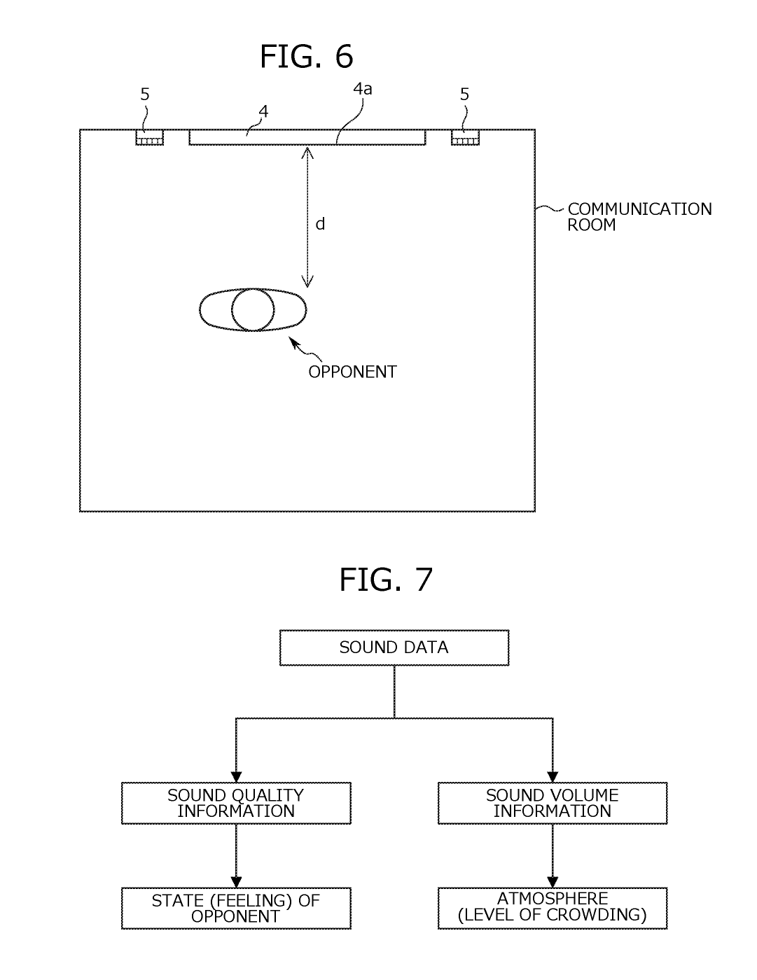

Then, the home server 1 specifies the position of the opponent based on the sound amplitude and phase specified for each microphone 3. The “position of the opponent” is the sound image position obtained from the difference in the amplitude and the phase of the sound collected by each microphone 3 between the microphones 3. Simply speaking, the home server 1 specifies, as illustrated in FIG. 6, the distance between the display device 4 and the opponent (in FIG. 6, the distance indicated by a reference character “d”) and the direction of the opponent as viewed from the display device 4 (e.g., whether the opponent is positioned on the right or left side as viewed from the display device 4).

Note that other methods than above may be used as the method for specifying the position of the opponent, and for example, an image processing technique (specifically, the technique of specifying the position of a predetermined region in an image) may be applied to the video file data received from the opponent side server, strictly speaking the video image data extracted from the video file data, to specify the position of the opponent.

In the case where the distance d from the reference position (in the present embodiment, the arrangement position of the display device 4) is specified as the position of the opponent, the human sensor 8 with a distance calculation function may be used. With the human sensor 8, the distance d between the reference position and the opponent is calculated at the same time as detection of the opponent in the communication room. Thus, the position of the opponent may be specified from such a calculation result.

At the step S022 of specifying the atmosphere etc. of the opponent, the feeling of the opponent and the level of crowding in the communication room are specified from the video file data received from the opponent side server, strictly speaking the sound data extracted from the video file data. More specifically, the quantified information (sound quality information and sound volume information) of the quality and the volume of the sound indicated by the sound data can be obtained by analysis of the sound data. As illustrated in FIG. 7, the feeling of the opponent is specified from the sound quality information, and the level of crowding is specified from the sound volume information.

More specifically, the sound quality information is information obtained in such a manner that spectral analysis is applied to the sound data, and is specifically information indicating a first formant frequency and a second formant frequency. The first and second formant frequencies are set at values of coordinate axes, and a coordinate corresponding to the above-described sound quality information in a coordinate space (hereinafter referred to as a “sound space”) defined by the coordinate axes is calculated. Further, when the sound space is mapped on a well-known feeling space, a coordinate (i.e., a coordinate in the feeling space) corresponding to the above-described calculated coordinate is specified as a value indicating the feeling of the opponent.

The sound volume information is information obtained in such a manner that the amplitude level and the amplitude change of the sound indicated by the sound data are caught. Then, a value obtained by assignment of the amplitude level and the amplitude change of the sound indicated by the sound volume information to a predetermined arithmetic formula is specified as the level of crowding (atmosphere) in the communication room.

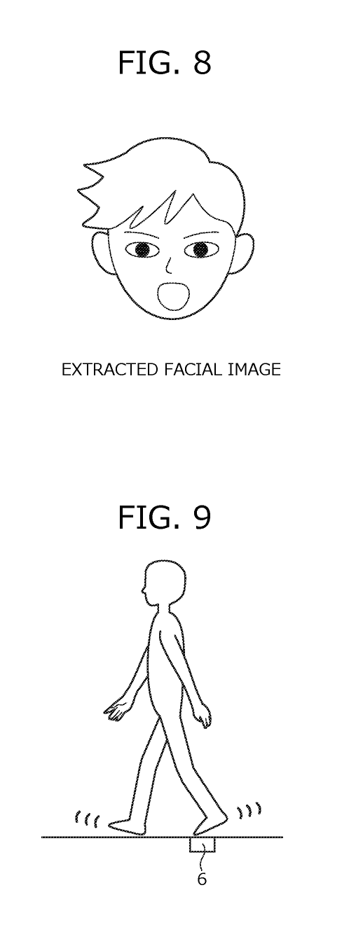

At the step S023 of specifying the expression of the opponent, the video image data is extracted from the video file data received from the opponent side server, and then, an opponent's facial image is, as illustrated in FIG. 8, extracted from the video image indicated by the video image data. Then, a well-known image processing technique (specifically, the technique of identifying an expression from a facial image) is applied to the extracted facial image, thereby specifying the expression/feeling of the opponent.

At the step S024 of specifying the walking vibration of the opponent, the generation position (in other words, the position of the opponent) of the walking vibration illustrated in FIG. 9 is specified from the vibration data received from the opponent side server. More specifically, for each of the two right and left vibration sensors 6 placed in the communication room where the opponent is present, the above-described vibration data is analyzed to specify the amplitude and the phase of the walking vibration detected by the vibration sensors 6. Then, the generation position of the walking vibration is specified from the difference in the amplitude and the phase of the vibration detected by each vibration sensor 6 between the vibration sensors 6.

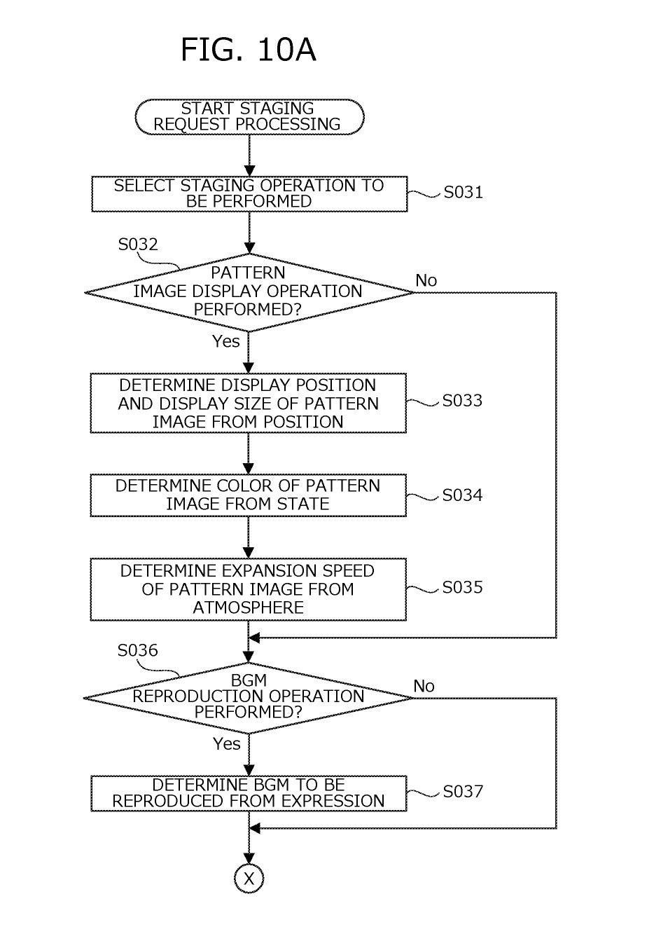

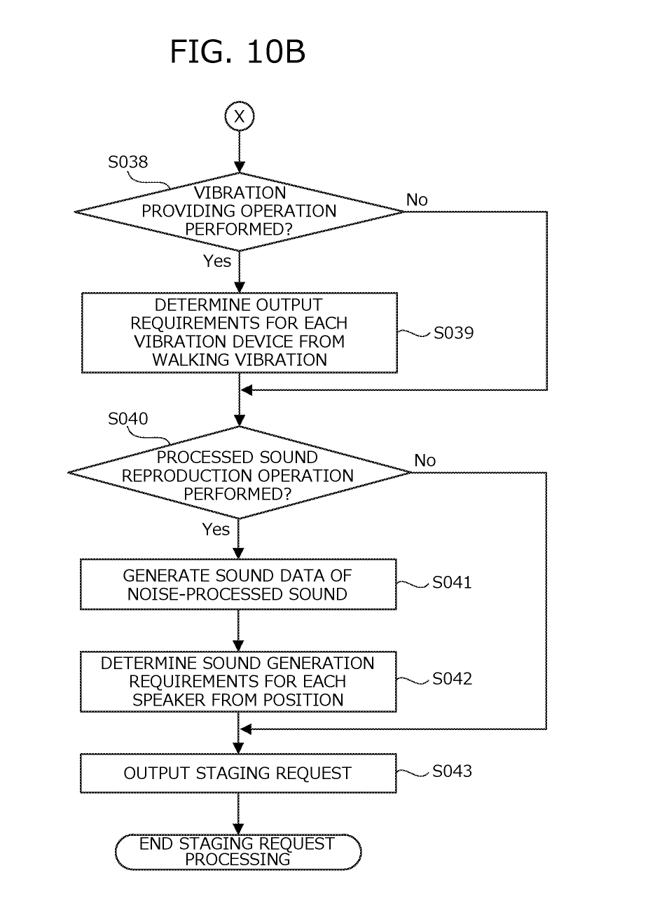

After the condition (the position, the expression/feeling, the atmosphere, the expression, and the walking vibration) of the opponent has been specified in the above-described steps, the home server 1 executes the staging request processing (S007). The staging request processing proceeds in the steps shown in FIGS. 10A and 10B. Specifically, the staging request processing begins from selection of the staging operation to be actually performed (S031). More specifically, the memory of the home server 1 stores data indicating, as the staging operation to be actually performed, the staging operation (i.e., the selected staging operation) selected by the user in advance. The home server 1 reads such data from the memory to specify the selected staging operation. Thus, the staging operation to be actually performed is selected from the plural types of staging operations.

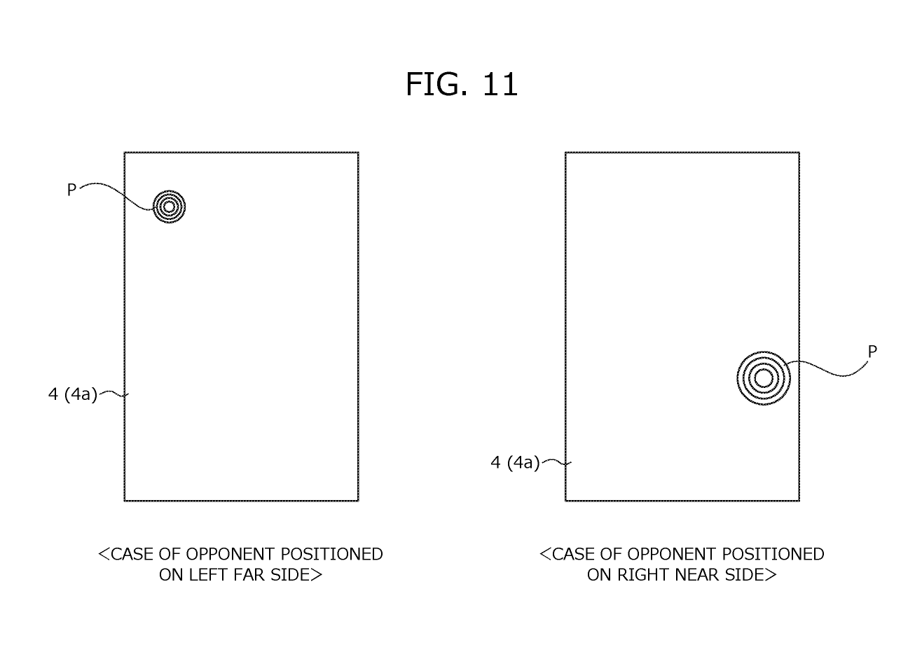

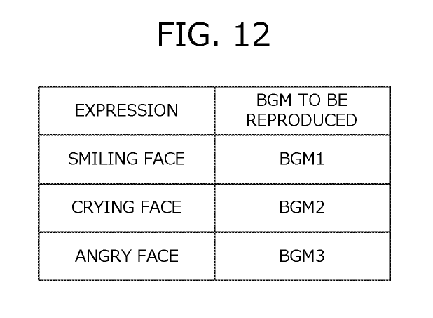

In the present embodiment, there are four types of staging operations. A first staging operation is the pattern image display operation of displaying a ripple-shaped pattern image P illustrated in FIG. 11 on the display screen of the display device 4. The program for displaying the ripple-shaped pattern image P is stored in the memory of the home server 1. In execution of the pattern image display operation, the CPU of the home server 1 reads and executes the above-described program. Thus, data (hereinafter referred to as “pattern image data”) for displaying the pattern image P is generated, and then, is transmitted to the display device 4. When the pattern image data is expanded in the display device 4, the pattern image P is displayed on the display screen of the display device 4. Further, in the present embodiment, the pattern image P indicating radial movement as in ripples is displayed.

Returning back to description of the types of the staging operations, a second staging operation is the BGM playback operation of playing back BGM via the speakers 5. There are plural candidates for BGM to be played back, and the data of each candidate is saved in the hard disk drive of the home server 1.

A third staging operation is the vibration providing operation of vibrating, by the vibration devices 7, the floor of the communication room where the user is present. A fourth staging operation is the processed sound playback operation of performing noise processing for the sound data obtained from the opponent side server to play back, via the speakers 5, the sound (i.e., the noise-processed sound) indicated by the processed data.

Returning back to the flow of the staging request processing, when the pattern image display operation is selected at the step S301 of selecting the staging operation (“Yes” at step S032), the home server 1 executes the staging mode setting processing of setting the mode for displaying the pattern image P. In such processing, the home server 1 sets the display mode corresponding to the specified results of the condition specifying processing S006.

Specifically, first, a display position and a display size on the display screen are, as the mode for displaying the pattern image P, determined (set) according to the opponent's position specified at the condition specifying processing S006 (S033). More specifically, the display position is set based on the direction of the opponent as viewed from the reference position, as illustrated in FIG. 11. For example, when the opponent is specified as being positioned on the left side with respect to the reference position, the pattern image P is displayed on the left side of the display screen as illustrated in the left view of the FIG. 11. On the other hand, when the opponent is specified as being positioned on the right side with respect to the reference position, the pattern image P is positioned on the right side of the display screen as illustrated in the right view of FIG. 11.

Moreover, the display size is set based on the distance d between the reference position and the opponent, as illustrated in FIG. 11. For example, when the distance d is relatively long, i.e., when the opponent is specified as being positioned relatively farther from the reference position, the display size is set at a small size as illustrated in the left view of FIG. 11. On the other hand, when the distance d is relatively short, i.e., when the opponent is specified as being positioned relatively nearer to the reference position, the display size is set at a large size as illustrated in the right view of FIG. 11.

Next, the color of the pattern image P is, as the mode for displaying the pattern image P, set according to the opponent's feeling specified at the condition specifying processing S006 (S034). More specifically, the feeling of the opponent is, as described above, specified as one coordinate in the feeling space. A well-known arithmetic formula for converting the coordinate in the feeling space into a single point in a color circle is applied, and as a result, the color corresponding to the opponent's feeling indicated as one coordinate in the feeling space is set.

Next, the movement speed (hereinafter referred to as an “expansion speed”) of the pattern image P expanding as in ripples is, as the mode for displaying the pattern image P, set according to the atmosphere specified at the condition specifying processing S006, specifically the level of crowding in the communication room (S035). More specifically, the formula for calculating the expansion speed from the value indicating the level of crowding is prepared in advance, and the crowding level value specified at the condition specifying processing S006 is assigned to the above-described formula. As a result, the expansion speed is set.

The pattern image P is displayed on the display screen in the display mode set by the above-described steps, and as a result, the position and the feeling of the opponent and the level of crowding in the communication room can be indirectly informed without displaying the video image of the opponent. That is, the pattern image P is displayed as the sign for transmitting the sense of presence of the opponent and the surrounding atmosphere of the opponent in the communication room.

When the BGM playback operation is selected at the step S031 of selecting the staging operation (“Yes” at S036), the home server 1 executes the staging mode setting processing of setting the type of BGM to be played back. In such processing, the home server 1 selects the BGM corresponding to the specified results of the condition specifying processing S006 (S037). Specifically, table data indicating the correspondence between a facial expression and the BGM to be played back as shown in FIG. 12 is stored in the memory of the home server 1. The home server 1 refers to the table data to select, as the BGM targeted for playback, the BGM corresponding to the opponent's expression specified at the condition specifying processing S006. As a result of selecting the BGM targeted for playback by the above-described steps, when the specified expression of the opponent is, e.g., a smiling face, uptempo BGM or lively BGM is to be selected as the BGM targeted for playback. On the other hand, when the specified expression of the opponent is a crying face, slowtempo BGM or gentle BGM is to be selected as the BGM targeted for playback.

When the vibration providing operation is selected at the step S031 of selecting the staging operation (“Yes” at S038), the home server 1 executes the staging mode setting processing of setting output requirements (vibration generation requirements) for each of the vibration devices 7 provided respectively at two points on the right and left sides in the communication room. In such processing, the home server 1 sets the output requirements corresponding to the specified results of the condition specifying processing S006 (S039). Specifically, the vibration generation requirements (e.g., the amplitude and the phase of generated vibration) for each vibration device 7 are set such that the position of the floor of the user side communication room vibrates, the floor position corresponding to the generation position of the walking vibration specified at the condition specifying processing S006. Then, since vibration is generated at each vibration device 7 according to the set vibration generation requirements, the walking vibration of the opponent is reproduced at the floor of the user side communication room.

When the processed sound playback operation is selected at the step S031 of selecting the staging operation (“Yes” at S040), the home server 1 generates the sound data of the noise-processed sound (S041), and executes the staging mode setting processing of setting the sound generation requirements when the noise-processed sound is played back via the speakers 5. The sound data of the noise-processed sound is generated in such a manner that noise processing is performed for the sound data (strictly speaking, the sound data extracted from the video file data) obtained from the opponent side server. Meanwhile, in the staging mode setting processing of setting the sound generation requirements, the home server 1 sets the sound generation requirements corresponding to the specified results of the condition specifying processing S006 (S042). Specifically, the sound generation requirements (e.g., the volume and the phase of generated sound) for each speaker 5 are set such that the opponent's position specified at the condition specifying processing S006 and the sound image position for the noise-processed sound match with each other. Since the noise-processed sound is generated by each speaker 5 according to the set sound generation requirements, the noise-processed sound is played back such that the sound image position for the noise-processed sound is at a predetermined position (specifically, the display position of the opponent if the video image of the opponent is displayed on the display screen) of the display screen of the display device 4.

After the staging mode of each staging operation has been set by the above-described steps, the home server 1 generates the request for performing the staging operation in the set staging mode, and then, outputs the request to a corresponding device (S043). Specifically, the request for performing the pattern image display operation is output to the display device 4, the request for performing the BGM playback operation is output to each speaker 5, the request for performing the vibration providing operation is output to each vibration device 7, and the request for performing the processed sound playback operation is output to each speaker 5.

Then, the device having received the request for performing the staging operation performs the staging operation according to the request and the set staging mode. The user recognizes the performed staging operation so that the user can easily ascertain the condition of the opponent (specifically, the presence or absence of the opponent in the communication room, the feeling of the opponent, the expression of the opponent, the atmosphere in the communication room, etc.). With the opponent's condition ascertained as described above, the user can find a chance to have a dialogue with the opponent, simply speaking a clue to have a conversation with the opponent, while subsequently viewing the opponent's face on the display screen of the display device 4. Thus, smooth communication can be realized.

Returning back to the dialogue communication flow, the home server 1 analyzes, after execution of the staging request processing, the video file data and the vibration data having received from the opponent side server to determine whether or not the opponent's condition specified based on the above-described file changes (S008). As a result of determination, when the condition of the opponent changes (“Yes” at S008), the home server 1 repeats the condition specifying processing S006 and the staging request processing S007 in the above-described steps. That is, in the present embodiment, when the specified condition of the opponent changes, the staging mode is switched along with the condition change. The staging operation in the switched staging mode is performed by the display device 4, the speakers 5, and the vibration devices 7.

Specifically, e.g., when the position and the feeling of the opponent change while the pattern image display operation is being performed as the staging operation, the home server 1 specifies the position and the feeling after the change, and then, the display mode of the pattern image P is re-set (switched) according to the position and the feeling after the change. Then, the home server 1 re-executes the staging request processing, and generates the request for performing the pattern image display operation such that the pattern image P is displayed in the switched display mode. Then, such a request is output to the display device 4.

As described above, in the present embodiment, when the state of the opponent and the surrounding atmosphere of the opponent change, the staging mode of the staging operation is switched along with such change. Thus, when the condition of the opponent changes, the user can notice such change.

The home server 1 determines whether or not the user operation of beginning the reproduction operation is performed while the staging operation is being performed (S009). The “user operation of beginning the reproduction operation” is an operation performed by the user to reproduce the video image and the voice of opponent via the display device 4 and the speakers 5. In the present embodiment, such an operation corresponds to the operation of touching the touch panel 4a.

When the user operation of beginning the reproduction operation is performed, i.e., when the touch panel 4a receives the touch operation, the home server 1 receives the signal output from the touch panel 4a to recognize the above-described user operation. Thereafter, the home server 1 executes the reproduction request processing of causing the display device 4 and the speakers 5 to perform the reproduction operation (S010). In the reproduction request processing, the home server 1 generates the request for displaying, on the display screen, the video image indicated by the video image data having received from the opponent side server, and then, outputs such a request to the display device 4. Moreover, in this processing, the home server 1 generates the request for playing back the sound indicated by the sound data having received from the opponent side server, and then, outputs such a request to each speaker 5.

In execution of the reproduction request processing, the display device 4 and each speaker 5 receive the request for performing the reproduction operation, and then, perform the reproduction operation according to such a request. Thus, the staging operation having been performed so far is terminated. Accordingly, the video image of the opponent is displayed on the display screen of the display device 4, and the voice of the opponent is played back via the speakers 5.

As described above, in the present embodiment, the staging operation is performed before the reproduction operation, and the reproduction operation begins under the condition where the user operation of beginning the reproduction operation is performed during the staging operation. In other words, the reproduction operation of reproducing the video image and the voice of the opponent does not promptly begin even after the dialogue communication flow has begun, and is suspended until the user operation of beginning the reproduction operation is received. As a result, the situation where the reproduction operation unexpectedly begins is avoided, and therefore, the privacy of the opponent can be more effectively protected.

For protection of the privacy of the opponent, the following is more preferable: after the user operation of beginning the reproduction operation has been received, the reproduction operation begins when an opponent's approval for start of the reproduction operation is obtained. Specifically, e.g., when the opponent touches the opponent side touch panel 4a as an approval operation, the opponent side server may detect the touch operation to transmit data indicating such a detection result, and then, the reproduction operation may begin when such data is received by the user side home server 1.

Note that the vibration providing operation of the staging operation is continuously performed as one of the reproduction operations after the user operation of beginning the reproduction operation has been received. When any of the user and the opponent exits from the communication room and the human sensor 8 no longer detects a person (S011), the user side home server 1 and the opponent side server terminate communication. At this point, the dialogue communication flow ends.

### Other Embodiments

In the above-described embodiment, the example of the condition ascertainment unit of the present invention has been described. Note that the above-described embodiment has been set forth as an example for the sake of easy understanding of the present invention, and is not intended to limit the present invention. Changes and modifications can be made to the present invention without departing from the gist of the present invention, and needless to say, the present invention includes all equivalents thereof.

In the above-described embodiment, the staging operation is performed as the preliminary step of performing the reproduction operation. That is, the above-described embodiment is based on the condition that the reproduction operation is performed after the staging operation, but the present invention is not limited to such a configuration. Only the staging operation may be performed not based on the condition that the reproduction operation is performed. That is, for the purpose of easily checking the state of the opponent and the surrounding atmosphere of the opponent without reproducing the video image and the voice of the opponent, the condition ascertainment unit of the present invention may be used.

In the above-described embodiment, the position and the state of the opponent and the atmosphere in the space where the opponent is present are all specified for ascertaining the condition of the opponent, but the present invention is not limited to such a configuration. At least one of the above-described items may be specified.

In the above-described embodiment, the case where there are a single user and a single opponent has been described as an example, but there may be a plurality of opponents. Further, the opponent may be a specified or unspecified person. In particular, in the case where the opponent is the unspecified person, the condition of the unspecified person is ascertained by the condition ascertainment unit of the present invention, and as a result, an effect in crime prevention and security is expected.

The procedure of the steps described in the above-described embodiment (e.g., the procedure of the steps S021 to S024 of specifying the items on the condition of the opponent) has been set forth as a mere example, and other procedures may be employed as long as the purpose for performing each step is accomplished.

### REFERENCE SIGNS LIST

1: home server (control device)
2: camera
3: microphone
4: display device (staging device, reproduction device)

4a: touch panel (operation receiving equipment)
5: speaker (staging device, reproduction device)
6: vibration sensor
7: vibration device (staging device)
8: human sensor
100 present unit (condition ascertainment unit)
P pattern image

1. A condition ascertainment unit used by a user for ascertaining a condition of an opponent in a remote location, comprising:
a staging device configured to perform a staging operation being recognizable by the user and being different from an operation of reproducing a video image and voice of the opponent; and
a control device configured to control the staging device to perform the staging operation and to communicate with an opponent side terminal used by the opponent,
wherein the control device executes
data obtaining processing of obtaining data via a communication with the opponent side terminal, the data indicating at least one of a presence or absence of the opponent, a video image including an image of the opponent, sound collected in a space where the opponent is present, or vibration generated by action of the opponent,
content specifying processing of specifying a content on at least one of a position of the opponent, a state of the opponent, or atmosphere in the space where the opponent is present from the data obtained by the data obtaining processing, and
staging request processing of causing the staging device to perform the staging operation in a staging mode corresponding to the content specified by the content specifying processing.

2. The condition ascertainment unit according to claim 1, wherein
the control device obtains sound data indicating the sound collected in the space where the opponent is present in the data obtaining processing and specifies at least one of a volume or a quality of the sound indicated by the sound data in the content specifying processing.

3. The condition ascertainment unit according to claim 2, wherein
the control device
obtains position data indicating the position of the opponent and the sound data in the data obtaining processing, and
specifies at least one of the volume or the quality of the sound indicated by the sound data and specifies the position of the opponent with respect to a reference position in the space where the opponent is present in the content specifying processing.

4. The condition ascertainment unit according to claim 1, wherein
the staging device executes the staging operation of displaying a pattern image on a display screen, and
the control device, in execution of the staging request processing,
sets a display mode of the pattern image as the staging mode, and
causes the staging device to perform the staging operation such that the pattern image is displayed in the display mode corresponding to the content specified by the content specifying processing.

5. The condition ascertainment unit according to claim 4, wherein
when the content specified by the content specifying processing changes, the control device, in the staging request processing,
switches the display mode along with the content change, and
causes the staging device to perform the staging operation such that the pattern image is displayed in the display mode after being switched.

6. The condition ascertainment unit according to claim 1, further comprising:
a reproduction device configured to perform a reproduction operation of reproducing at least one of the video image and the voice of the opponent; and
an operation receiving equipment configured to receive an operation performed by the user to cause the reproduction device to perform the reproduction operation,
wherein when the operation receiving equipment receives the operation, the control device further executes reproduction request processing of controlling the reproduction device to perform the reproduction operation, and
the operation receiving equipment receives the operation while the staging device is performing the staging operation.

7. The condition ascertainment unit according to claim 6, wherein the staging device and the reproduction device are configured as a common device.
